(19) United States
(12) Patent Application Publication
(10) Pub. No.: US 2024/0083368 A1
(43) Pub. Date: Mar. 14, 2024

(54) ADJUSTABLE CYCLE RACK AND ASSOCIATED METHODS

(71) Applicants: Lauren Kostoff, Livingston, MT (US); Jessica Kostoff, Livingston, MT (US)

(72) Inventors: Lauren Kostoff, Livingston, MT (US); Jessica Kostoff, Livingston, MT (US)

(21) Appl. No.: 18/361,726

(22) Filed: Jul. 28, 2023

Related U.S. Application Data
(60) Provisional application No. 63/393,637, filed on Jul. 29, 2022.

(51) Int. Cl. B60R 9/10

(52) U.S. Cl. CPC B60R 9/10

(57) ABSTRACT

The adjustable cycle rack is for one or more cycles, configured to be selectively used with multiple different sized cycles, and configured to be used during transport and after transport. The adjustable cycle rack includes an elongated main frame, a first jackstand coupled to a first end of the elongated main frame, and a second jackstand coupled to a second end of the elongated main frame. Each of the first and second jackstands may include a lifter frame, a lifter carried by the lifter frame and adjustable to a selected height, an upper cycle mount coupled to the lifter and configured to support a cycle thereon at the selected height. A locking mechanism is configured to engage a portion of the cycle and secure the cycle to the upper cycle mount.

### FIELD OF THE INVENTION

The present invention relates to cycle racks, and more specifically to an adjustable cycle rack for multiple cycles and associated methods.

### BACKGROUND

Currently the most common way to secure dirt bikes during travel is by using tie-down straps. When trying to secure multiple dirt bikes in a vehicle with tie down straps the straps get twisted and tangled. The tie-down straps put constant tension on the fork seals which can cause premature wear of the springs and puts stress on the seals, graphics get scratched and cables get worn from rubbing. Tie down straps can also become loose during travel and if the front or back tire of the dirt bike is not chocked or positioned against a vertical surface or otherwise secured the dirt bike may moveback and forth.

Various stands for dirt bikes and motorcycles exist. U.S. Pat. No. 8,360,252 is directed to a free standing dirt bike stand. U.S. Pat. No. 6,581,784 is directed to a motorcycle stand. U.S. Published Application No. 2006/0045685 is directed to a motorcycle stand and lift. U.S. Published Application No. 2004/0060878 is directed to a cycle display stand. Typical stands are not multi-use for transporting, storage and maintenance of dirt bikes or motorcycles.

Current dirt bike stands are for single dirt bike use. It can be challenging to get the bikes up on them and each dirt bike has its own stand, example: if you have multiple dirt bike riders (e.g. with four dirt bikes) you will need four stands. Some dirt bikes have kickstands that are mounted on the dirt bike. These kickstands often sink in soft ground, are not adjustable for uneven surfaces, and do not provide the dirt bike with enough support to guarantee stability, and often result in the dirt bike tipping over. Then, to lock up dirt bikes for safety, currently you have to rearrange each dirt bike, string a chain through the frame of each dirt bike then pad lock the ends together. This can be a time consuming and frustrating task.

This background information is provided to reveal information believed by the applicant to be of possible relevance to the present invention. No admission is necessarily intended, nor should be construed, that any of the preceding information constitutes prior art against the present invention.

### SUMMARY OF THE EMBODIMENTS

An object of the present invention may be to provide an adjustable cycle rack (e.g. dirt bike stand) that is able to be used during travel, can be moved out of the transport vehicle to be used as a stand on the ground, is adjustable to be used with multiple bikes and different sizes of dirt bikes, and offers a convenient way to lock the dirt bikes for security.

Objects and advantages may be provided by an adjustable cycle rack for one or more cycles, configured to be selectively used with multiple different sized cycles, and configured to be used during transport and after transport. The adjustable cycle rack including an elongated main frame, a first jackstand coupled to a first end of the elongated main frame, and a second jackstand coupled to a second end of the elongated main frame. Each of the first and second jackstands includes a lifter frame, a lifter carried by the lifter frame and adjustable to a selected height, an upper cycle mount coupled to the lifter and configured to support a cycle thereon at the selected height, and a locking mechanism configured to engage a portion of the cycle and secure the cycle to the upper cycle mount.

Additionally, and/or alternatively, the elongated main frame includes a central frame housing carrying first and second extendable spacing rods which are extendable from respective first and second ends of the central frame housing. The first jackstand is coupled to the first extendable spacing rod, and the second jackstand is coupled to the second extendable spacing rod.

Additionally, and/or alternatively, each of the first and second jackstands includes a biasing member within the lifter frame and biasing the lifter upward. The biasing member may be a gas pressure spring.

Additionally, and/or alternatively, the upper cycle mount includes a mounting plate. The mounting plate may include at least one bumper on a top surface thereof.

Additionally, and/or alternatively, the locking mechanism comprises first and second peg bolts configured to engage respective pegs of the cycle and secure the cycle to the upper cycle mount. The locking mechanism may further include a driver configured to selectively actuate the first and second peg bolts between an unlocked position and a locked position that engages the respective pegs of the cycle.

Additionally, and/or alternatively, the main frame includes at least one floor coupler.

Additionally, and/or alternatively, each of the first and second jackstands includes a set of wheels.

Additionally, and/or alternatively, an additional jackstand may be coupled to the elongated mainframe between the first and second ends thereof.

Another embodiment is directed to an adjustable cycle rack for one or more cycles, configured to be selectively used with multiple different sized cycles, and configured to be used during transport and after transport. The adjustable cycle rack includes an elongated main frame comprising a central frame housing carrying first and second extendable spacing rods which are extendable from respective first and second ends of the central frame housing. A first jackstand is coupled to the first extendable spacing rod, and a second jackstand coupled to the second extendable spacing rod. Each of the first and second jackstands includes an upper cycle mount configured to support a cycle thereon at a selected height, and a locking mechanism configured to engage a portion of the cycle and secure the cycle to the upper cycle mount.

Additionally, and/or alternatively, each of the first and second jackstands includes a biasing member biasing the upper cycle mount upward. The biasing member may be a gas pressure spring.

Additionally, and/or alternatively, the upper cycle mount comprises a mounting plate. The mounting plate may include at least one bumper on a top surface thereof.

Additionally, and/or alternatively, the locking mechanism comprises first and second peg bolts configured to engage respective pegs of the cycle and secure the cycle to the upper cycle mount. The locking mechanism may also include a driver configured to selectively actuate the first and second peg bolts between an unlocked position and a locked position that engages the respective pegs of the cycle.

Additionally, and/or alternatively, the main frame includes at least one floor coupler.

Additionally, and/or alternatively, an additional jackstand is coupled to the elongated mainframe between the first and second ends thereof.

Accordingly, the cycle rack (e.g., dirt bike support stand) is designed to keep multiple sizes (e.g. 50 cc-500 cc, and larger) of dirt bikes upright and standing during travel, at the track, in the garage or anywhere you bring your dirt bike, with the added security of having an easy way to lock the dirt bikes. The invention eliminates the need to use multiple different systems for travel, securing, etc. The stand functions as a secure mount to safely keep upright each dirt bike during travel and is easily and quickly transferable out of a trailer or truck bed, for example. The dirt bike stand is also a convenient place for dirt bike maintenance/mechanic work.

### BRIEF DESCRIPTION OF THE DRAWINGS

The example embodiments are best understood from the following detailed description when read with the accompanying drawing figures. In fact, the dimensions may be arbitrarily increased or decreased for clarity of discussion. Wherever applicable and practical, like reference numerals refer to like elements.

FIG. 1 is a perspective view illustrating an example embodiment of an adjustable cycle rack in accordance with features of the present invention.

FIG. 2 is another perspective view illustrating details of the adjustable cycle rack of the of FIG. 1 in an extended position.

FIG. 3 is another perspective view illustrating details of the adjustable cycle rack of FIG. 1 and an additional jackstand.

FIG. 4 is a side view illustrating details of the adjustable cycle rack of FIG. 3.

FIG. 5 is a perspective view illustrating details of a portion of the adjustable cycle rack of FIG. 1.

FIG. 6 is a perspective view illustrating details of a portion of the adjustable cycle rack of FIG. 1.

FIG. 7 is a perspective view illustrating details of the jackstand of the adjustable cycle rack of FIG. 1.

FIGS. 8A, 8B and 8C are side views illustrating details of the locking mechanism of the adjustable cycle rack of FIG. 1.

FIGS. 9-12 are perspective views illustrating the adjustable cycle rack of FIG. 1 while in use mounting various dirt bikes.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

Although the present description may refer to dirt bikes, the embodiments are applicable for use with any cycles. Also, the term “jackstand” is meant to include both static and dynamic jackstands.

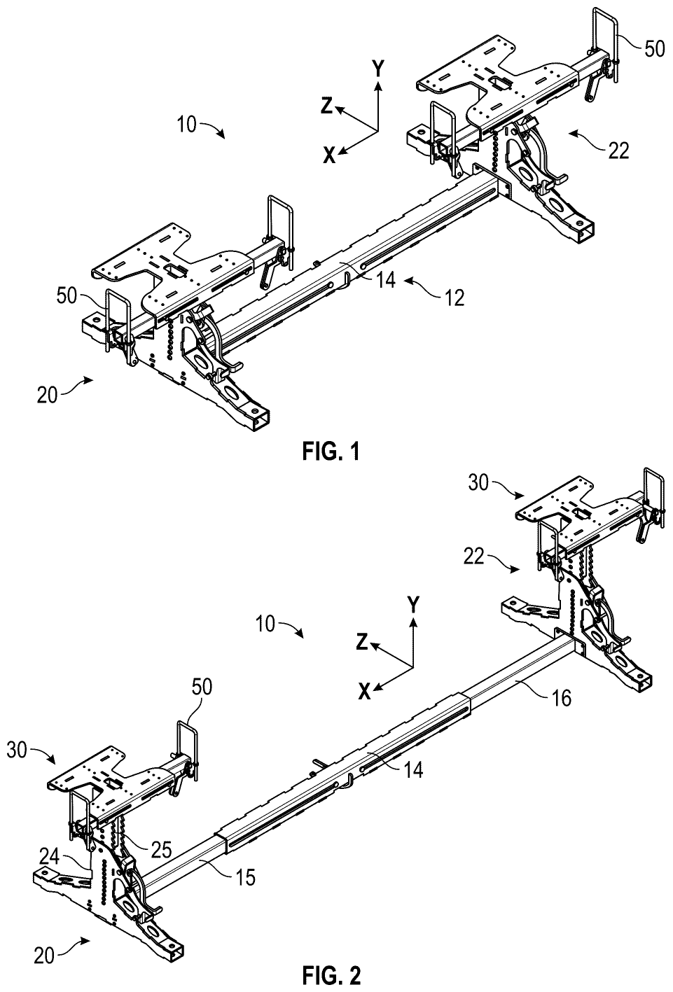

FIGS. 1-7 illustrate an example embodiment of an adjustable cycle rack 10 in accordance with features of the present invention. The adjustable cycle rack 10 is for one or more cycles, is configured to be selectively used with multiple different sized cycles, and is configured to be used during transport (e.g., within a trailer or truck bed) and after transport (e.g., in a garage or on the ground).

The adjustable cycle rack 10 includes an elongated main frame 12. The elongated main frame 12 may include a central frame housing 14 carrying first and second extendable spacing rods 15/16 which are extendable from respective first and second ends of the central frame housing 14

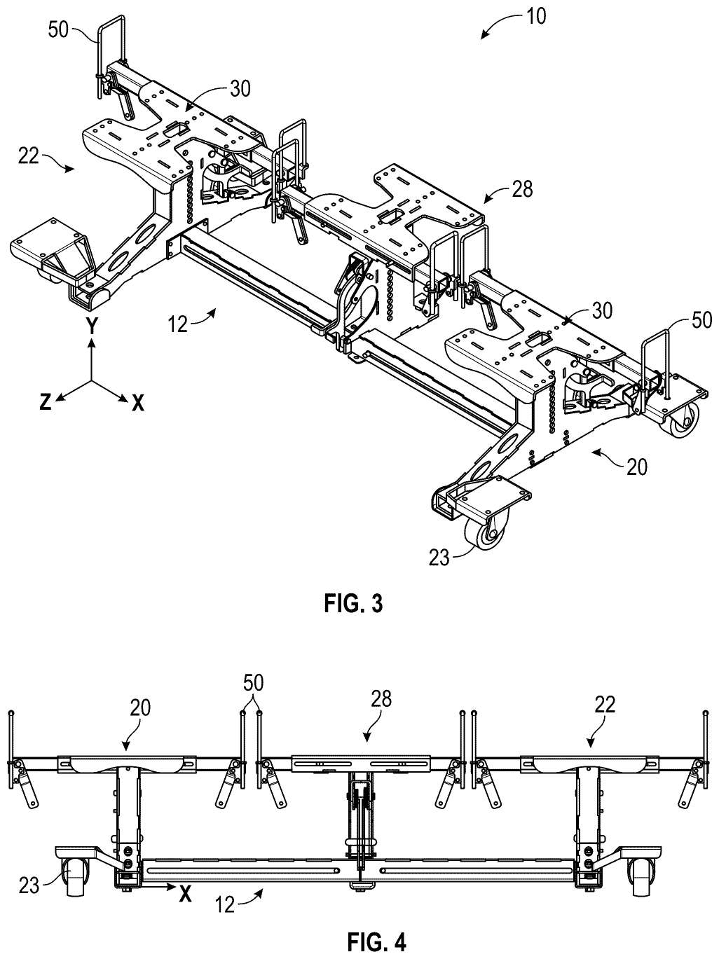

A first jackstand 20 is coupled to a first end of the elongated main frame 12, and a second jackstand 22 is coupled to a second end of the elongated main frame 12. An additional jackstand 28 may be coupled to the elongated mainframe 12 between the first and second ends thereof, as illustrated in FIGS. 3 and 4, for example. The additional jackstand 28 may also define a seat, for example, for a technician. Each of the jackstands 20, 22, 28 may include a lifter frame 24 and a lifter 25 carried thereby. The lifter 25 is adjustable to a selected height. In other words, the height of the jackstand may be adjusted and used to support a cycle that is raised. Lifting-assisted and manually pinned versions are contemplated.

Referring specifically to FIG. 2, the first jackstand 20 may be coupled to the first extendable spacing rod 15, and the second jackstand 22 may be coupled to the second extendable spacing rod 16. Each of the jackstands 20, 22, 28 may include a biasing member 29 associated with the lifter frame 24 and biasing the lifter 25 upward. The biasing member 29 may be a gas pressure spring 29 (FIG. 6) or coil spring 29′ (FIG. 7), for example. Other biasing member types are contemplated, such as springs, air, pneumatic, pumps, etc. Each of the first and second jackstands 20, 22 may include a set of wheels 23, for example, as illustrated in FIGS. 3 and 4.

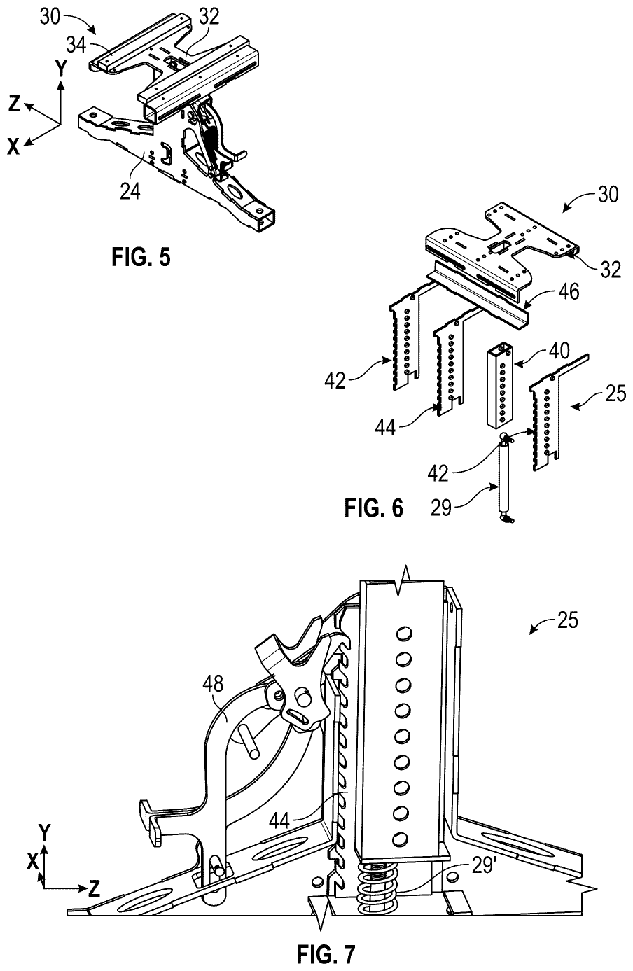

An upper cycle mount 30 is coupled to the lifter 25 and configured to support a cycle thereon at the selected height. The upper cycle mount 30 may include a mounting plate 32. The mounting plate 32 may include at least one bumper 34 on a top surface thereof as illustrated in FIG. 5. Referring now to FIG. 6, an example of a lifter frame 25 is shown. The lifter frame 25 includes lifter core 40, lifter plates 42 and locking plate 44. A closing bracket 46 may also be included with mounting plate 32 to create a slide rail. As shown in FIG. 7, an actuator 48 may be included to engage and actuate the lifter plates 42 and locking plates 44 to raise and/or lower the upper cycle mount 30.

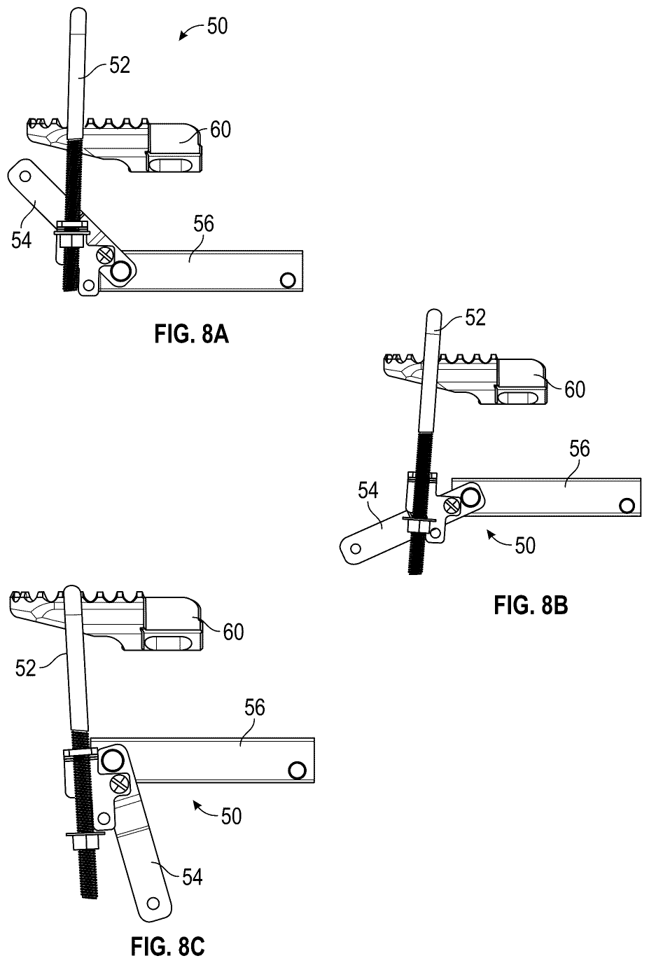

A locking mechanism 50 is configured to engage a portion of the cycle and secure the cycle to the upper cycle mount. For example, as best illustrated in FIGS. 8A, 8B, and 8C, the locking mechanism 50 may include peg bolts 52 configured to engage respective pegs of the cycle and secure the cycle to the upper cycle mount 30. Peg bolts 52 may, for example, be single bolts and/or U-bolts, etc. The locking mechanism 50 may further include a driver 54 configured to selectively actuate the first and second peg bolts 52 between an unlocked position (FIG. 8A), through an actuation or transition stage (FIG. 8B) and a locked position (FIG. 8C) that engages the respective pegs 60 of the cycle. The driver 54 is coupled to slider 56 which slides within the slide rail defined by the closing bracket 46 and the mounting plate 32. This arrangement allows the locking mechanism 50 to be adjustable for different widths, for example, of pegs 60.

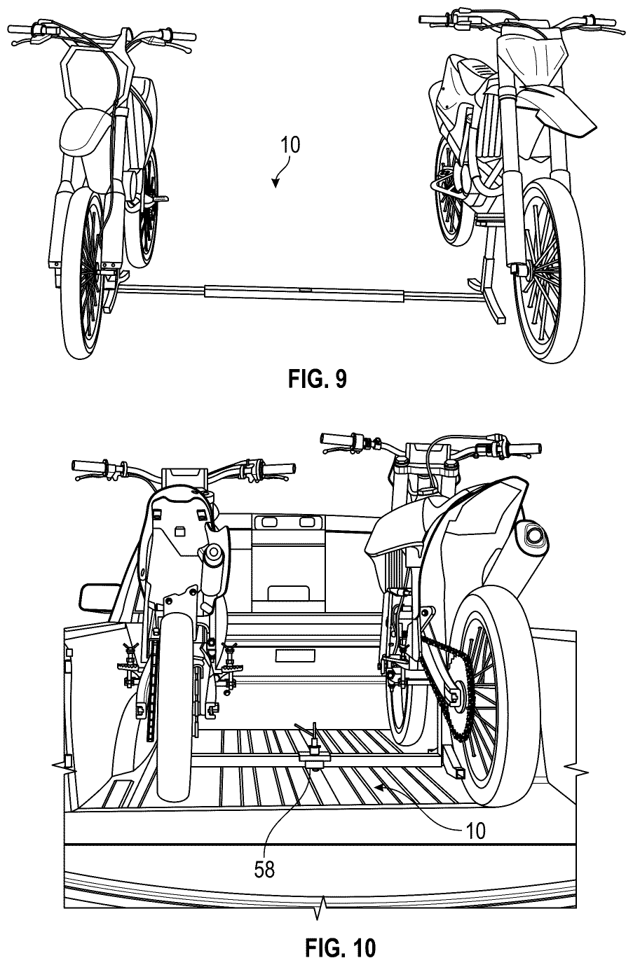

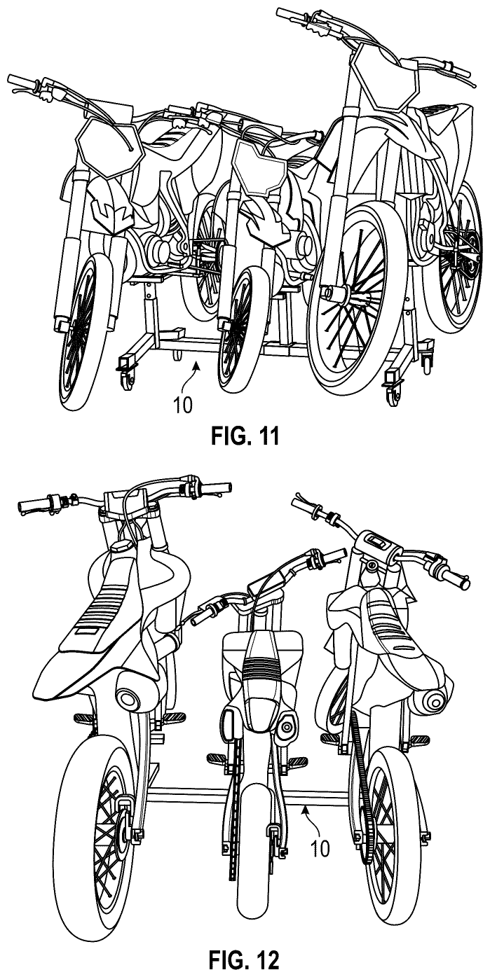

FIGS. 9-12 are perspective views illustrating the adjustable cycle rack 10 while in use mounting various dirt bikes. The elongated main frame 12 may include at least one floor coupler 58 (e.g. as shown in FIG. 10) to secure the adjustable cycle rack 10 to the floor of a truck or trailer bed, for example. The floor coupler 58 may be a turnbuckle, for example, or any other mechanism to securely couple the adjustable cycle rack 10 to the floor.

Typically, dirt bikes had to be loaded with the seemingly endless strapping, scratching graphics, and constant load on the fork seals. There may be children around playing and wanting to climb up and sit on the dirt bikes, and if the dirt bikes are not properly secured then they are likely to fall over. Many times, dirt bikes may fall over because of wind gusts or uneven surfaces. Dirt bikes are often stolen and arranging dirt bikes close enough to be able to string a chain through all of the dirt bikes while they are on separate stands, kick stands or leaning against something is time consuming, inconvenient, and difficult. The stand of the present invention is a simpler and more convenient way to secure, store, and lock dirt bikes. Other dirt bike stands do not provide the versatility offered by the present stand.

The rack or stand 10 addresses existing problems by being easily and quickly adjusted for differing heights of dirt bikes. It is easily and quickly installed in a transport trailer or vehicle and can be secured, for example, to D-rings, truck bed latches, rails . . . etc. Dirt bikes are secured (e.g. via each of the foot pegs) while putting no tension on the fork seals, and they are spaced out to prevent scratching and rubbing. When ready to unload, simply unlock the mechanism, remove the dirt bikes, disconnect the stand from the transport trailer or vehicle, place the stand on the ground and it is ready for multiple dirt bikes to be securely mounted.

Even children are able to properly secure their dirt bikes without help. It is no longer a struggle to untangle and use tie down straps. There is no need to use multiple different dirt bike stands. There is no longer stress about the suspension being cinched down and blowing out fork seals. If there is a small child around, there is no stress about a dirt bike falling on them. Loading and unloading the dirt bikes is quicker and requires less effort.

Dirt bikes no longer randomly fall over from wind, or a dog leash, or someone leaning on it, or uneven ground, or soft, muddy soil, for example. The stand is also a very convenient place to work on the dirt bikes, so a removable seat will make it more useful and comfortable.

The present invention may have also been described, at least in part, in terms of one or more embodiments. An embodiment of the present invention is used herein to illustrate the present invention, an aspect thereof, a feature thereof, a concept thereof, and/or an example thereof. A physical embodiment of an apparatus, an article of manufacture, a machine, and/or of a process that embodies the present invention may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

The above description provides specific details, such as material types and processing conditions to provide a thorough description of example embodiments. However, a person of ordinary skill in the art would understand that the embodiments may be practiced without using these specific details.

Some of the illustrative aspects of the present invention may be advantageous in solving the problems herein described and other problems not discussed which are discoverable by a skilled artisan. While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item. Thus, the scope of the invention should be determined by the appended claims and their legal equivalents, and not by the examples given.

1. An adjustable cycle rack for one or more cycles, configured to be selectively used with multiple different sized cycles, and configured to be used during transport and after transport, the adjustable cycle rack comprising:
an elongated main frame; and
a first jackstand coupled to a first end of the elongated main frame, and a second jackstand coupled to a second end of the elongated main frame;
each of the first and second jackstands comprising
a lifter frame,
a lifter carried by the lifter frame and adjustable to a selected height,
an upper cycle mount coupled to the lifter and configured to support a cycle thereon at the selected height, and
a locking mechanism configured to engage a portion of the cycle and secure the cycle to the upper cycle mount.

2. The adjustable cycle rack according to claim 1, wherein the elongated main frame comprises a central frame housing carrying first and second extendable spacing rods which are extendable from respective first and second ends of the central frame housing; and wherein the first jackstand is coupled to the first extendable spacing rod, and the second jackstand is coupled to the second extendable spacing rod.

3. The adjustable cycle rack according to claim 1, wherein each of the first and second jackstands includes a biasing member within the lifter frame and biasing the lifter upward.

4. The adjustable cycle rack according to claim 3, wherein the biasing member comprises a gas pressure spring.

5. The adjustable cycle rack according to claim 1, wherein the upper cycle mount comprises a mounting plate.

6. The adjustable cycle rack according to claim 5, wherein the mounting plate comprises at least one bumper on a top surface thereof.

7. The adjustable cycle rack according to claim 1, wherein the locking mechanism comprises first and second peg bolts configured to engage respective pegs of the cycle and secure the cycle to the upper cycle mount.

8. The adjustable cycle rack according to claim 7, wherein the locking mechanism further comprises a driver configured to selectively actuate the first and second peg bolts between an unlocked position and a locked position that engages the respective pegs of the cycle.

9. The adjustable cycle rack according to claim 1, wherein the main frame includes at least one floor coupler.

10. The adjustable cycle rack according to claim 1, wherein each of the first and second jackstands includes a set of wheels.

11. The adjustable cycle rack according to claim 1, further comprising an additional jackstand coupled to the elongated mainframe between the first and second ends thereof.

12. An adjustable cycle rack for one or more cycles, configured to be selectively used with multiple different sized cycles, and configured to be used during transport and after transport, the adjustable cycle rack comprising:
an elongated main frame comprising a central frame housing carrying first and second extendable spacing rods which are extendable from respective first and second ends of the central frame housing; and
at first jackstand coupled to the first extendable spacing rod, and a second jackstand coupled to the second extendable spacing rod;
each of the first and second jackstands comprising an upper cycle mount configured to support a cycle thereon at a selected height, and a locking mechanism configured to engage a portion of the cycle and secure the cycle to the upper cycle mount.

13. The adjustable cycle rack according to claim 12, wherein each of the first and second jackstands includes a biasing member biasing the upper cycle mount upward.

14. The adjustable cycle rack according to claim 13, wherein the biasing member comprises a gas pressure spring.

15. The adjustable cycle rack according to claim 12, wherein the upper cycle mount comprises a mounting plate.

16. The adjustable cycle rack according to claim 15, wherein the mounting plate comprises at least one bumper on a top surface thereof.

17. The adjustable cycle rack according to claim 12, wherein the locking mechanism comprises first and second peg bolts configured to engage respective pegs of the cycle and secure the cycle to the upper cycle mount.

18. The adjustable cycle rack according to claim 17, wherein the locking mechanism further comprises a driver configured to selectively actuate the first and second peg bolts between an unlocked position and a locked position that engages the respective pegs of the cycle.

19. The adjustable cycle rack according to claim 12, wherein the main frame includes at least one floor coupler.

20. The adjustable cycle rack according to claim 12, further comprising an additional jackstand coupled to the elongated mainframe between the first and second ends thereof.
